(19) United States
(12) Patent Application Publication
(10) Pub. No.: US 2016/0122543 A1
(43) Pub. Date: May 5, 2016

(54) Pollution Control System And Method For Hot-Mix Asphalt Manufacturing

(71) Applicant: Robert E. Frank, Linwood, NJ (US)

(72) Inventor: Robert E. Frank, Linwood, NJ (US)

(21) Appl. No.: 14/932,463

(22) Filed: Nov. 4, 2015

Related U.S. Application Data
(60) Provisional application No. 62/075,069, filed on Nov. 4, 2014.

(51) Int. Cl. C08L 95/00; B01D 53/86; B01D 53/72; B01D 53/74

(52) U.S. Cl. CPC C08L 95/00; B01D 53/74; B01D 53/8668; B01D 53/72; B01D 2257/708; C08L 2555/32; C08L 2555/22; C08L 2555/34

(57) ABSTRACT

A pollution control device for a hot-mix asphalt manufacturing system includes a filter that receives and filters emissions from a rotary dryer. The filter may include a pre-filter and/or a fiber bed filter. The filtered emissions are then sent to an oxidizer where they are heated to remove hydrocarbons. Heat energy from the emissions from the oxidizer is used to pre-heat emissions introduced into the oxidizer.

### FIELD OF THE INVENTION

The present teachings relate generally to pollution control and, more specifically, to pollution control devices for hot-mix asphalt manufacturing systems capable of producing high recycle content products.

### BACKGROUND OF THE INVENTION

Known hot-mix asphalt manufacturing systems include a burner, rotary dryer, and pollution control devices. The burner/rotary dryer assembly heats the mineral aggregate. The pollution control device treats emissions from combustion and heating to remove particulates and in some cases hydrocarbons before releasing emissions into the atmosphere.

Conventional asphalt manufacturing systems typically use cyclones or knock-out boxes, and large bag houses to remove airborne fine particulates. U.S. Pat. No. 5,322,367, the content of which is incorporated by reference in its entirety, discloses use of a bag house for asphalt manufacturing. The '367 patent relies on a plurality of sensors and computers to adjust the system and teaches that an oxidizer is unnecessary.

Frequently, systems designed to produce high recycle content asphalt pavements use expensive and/or complicated indirect heating systems to minimize formation of hydrocarbon emissions, or a second rotary dryer into which the hydrocarbon laden exhaust gases are vented for dilution or incineration. Indirect heating systems tend to be thermodynamically inefficient, expensive to build, and very limited in production capacity. Systems that depend on a second rotary dryer disadvantageously prevent one rotary dryer from being used without the other and are not suitable for 100% recycle content mixtures. U.S. Pat. No. 5,478,530, the content of which is incorporated by reference in its entirety, discloses use of two dryers for asphalt manufacturing, a primary dryer and a finishing dryer, and a catalytic reactor.

U.S. Pat. No. 6,832,850, the content of which is incorporated by reference in its entirety, was previously issued to the inventor of the present application and discloses a transportable hot-mix asphalt manufacturing and pollution control system for use with high percentage recycled asphalt product (RAP). The '850 patent discloses use of a pre-filter, cooling device, and fiber bed filter for pollution control.

Traditional pollution control devices for conventional asphalt manufacturing suffer from a number of disadvantages when used in high recycle systems. They are generally not compatible with recycled asphalt products (RAP) or cannot accept commingled RAP and virgin asphalt aggregates, which create undesirable hydrocarbon emissions when exposing the asphalt coated RAP to hot combustion gases. The filter media is easily blinded by the oil and dust laden exhaust gases and is not able to remove hydrocarbon aerosol or vapors.

Therefore, it would be beneficial to have a superior pollution control system and method for hot-mix asphalt recycling.

### SUMMARY OF THE INVENTION

The needs set forth herein as well as further and other needs and advantages are addressed by the present embodiments, which illustrate solutions and advantages described below.

Aspects of the present technology include, but are not limited to, a pollution control system for hot-mix asphalt manufacturing where the majority of raw material (e.g., 50-100%) is sourced from recycled asphalt pavements (RAP). A filter receives and filters emissions from a rotary dryer including, for example, the removal of fine particulates and hydrocarbon aerosols. The emissions then enter an oxidizer where they are heated and cleaned by removing hydrocarbons, including for example gaseous hydrocarbons (i.e., hydrocarbon vapors). Heat energy in the cleaned emissions from the oxidizer is used to pre-heat the emissions introduced into the oxidizer.

Other aspects of the present technology include a rotary dryer, parallel-flow, counter-flow, or otherwise, comprised of a heat source, a rotary drum with first and second ends and one or more inlets and outlets. An aggregate of ingredients for hot-mix asphalt are introduced into the rotary dryer through the inlet(s), are heated by the heat source and mixed through rotation of the rotatable drum, and the resulting hot-mix asphalt product is expelled through the outlet. In some cases, the aggregate includes a substantial amount of Recycled Asphalt Product (RAP). In other cases, the aggregate is comprised of a majority of RAP or entirely of RAP.

According to additional aspects of the present technology, emissions from the rotary dryer are introduced into a pollution control device comprised of a filter assembly and an oxidizer. The filter assembly may include an inertial separator, a pre-filter, a disposable filter, and/or a fiber bed filter, and other components. For example, the emissions may be introduced to the filter assembly, where the inertial separator removes larger particulates and contaminates, the pre-filter and disposable filter remove smaller particulates and contaminates, and the fiber bed filter removes any remaining particulates and contaminates in the form of an aerosol mist or otherwise. Those of skill in the art will recognize different combinations and arrangements of the filters in the filter assembly, and the present technology is not limited to any particular arrangement or combination described herein.

Further aspects of the present technology include passing the filtered emissions to an oxidizer, where pollutants such as hydrocarbons (including for example gaseous hydrocarbons) are removed using an oxidation process. Without limitation, any of catalytic oxidizers, thermal oxidizers, direct-fired oxidizers, or others may be used. In some aspects of the present technology, before the oxidized emissions are released into the ambient environment, heat from the emissions is collected and used to preheat other emissions as they are introduced to the oxidizer. In this way, the present technology conserves energy and reduces costs.

In some aspects of the present technology, a cooling device is used to cool emissions prior to or during the filtering process. For example, cooling may occur within the filter assembly. Cooling may occur in conjunction with the inertial separator, or later during filtering. In some embodiments, the cooling device takes the form of a cooling spray, although other embodiments will be well known to those skilled in the art. The present technology is not limited to these arrangements.

Other aspects of the present technology may include a conveyor system used to introduce the aggregate into the rotary dryer and remove the resulting hot-mix asphalt product from the rotary dryer. Still other aspects of the present technology may include a plurality of flights protruding from the interior, circumferential wall of the rotatable drum. In some embodiments these flights may be spaced radially and evenly along the circumferential wall, whereby the flights insulate the circumferential wall from the heat and form a combustion zone within the rotatable drum. These and other aspects of the present technology will be clear to those skilled in the art when referencing the below detailed description in conjunction with the accompanying drawings.

Other embodiments of the system and method are described in detail below and are also part of the present teachings.

For a better understanding of the present embodiments, together with other and further aspects thereof, reference is made to the accompanying drawings and detailed description.

### BRIEF DESCRIPTION OF THE DRAWINGS

FIG. 1 is a schematic cross-sectional view of a hot-mix asphalt manufacturing system.

FIG. 2 is a diagram of one embodiment of the pollution control device of FIG. 1.

### DETAILED DESCRIPTION OF THE INVENTION

The present teachings are described more fully hereinafter with reference to the accompanying drawings, in which the present embodiments are shown. The following description is presented for illustrative purposes only and the present teachings should not be limited to these embodiments.

A pollution control device according to the present teachings is adapted to treat emissions from a rotary dryer so that hydrocarbons and particulates are substantially removed from the emissions before they are released into a surrounding environment. In one embodiment, this is achieved with a filter that receives and filters the emissions from the rotary dryer. The filter may comprise a pre-filter and/or a fiber bed filter, although not limited thereto. The filtered emissions are then sent to an oxidizer where they are heated to remove hydrocarbons. Heat energy from emissions from the oxidizer is used to pre-heat the emissions introduced into the oxidizer.

In some embodiments, the oxidizer may comprise a catalytic oxidizer that heats incoming emissions to 500-800 F, reacts the hydrocarbons in the emissions, and produces carbon dioxide (CO2) and water (H2O). In alternative embodiments, the oxidizer may comprise a thermal oxidizer that heats the incoming emissions to 1600-1800 F to auto-ignite the hydrocarbons. One skilled in the art would appreciate the number of ways oxidation may be accomplished and the present teachings are not limited to any particular embodiments disclosed herein.

A system according to the present teachings is preferable to treat emissions in systems that directly heat recycled asphalt products (RAP). RAP is typically recovered from existing road surfaces and other areas by a milling process, or another suitable process, and is liberated into sand and stone particles for proportioning and reuse. The asphalt manufacturing industry has in the past used RAP in place of or in combination with virgin aggregates. However, doing so introduces a number of problems. For example, undesirable hydrocarbon emissions can be created when exposing the asphalt coated RAP to hot combustion gases in a dryer. These additional emissions can create challenges for traditional pollution control devices.

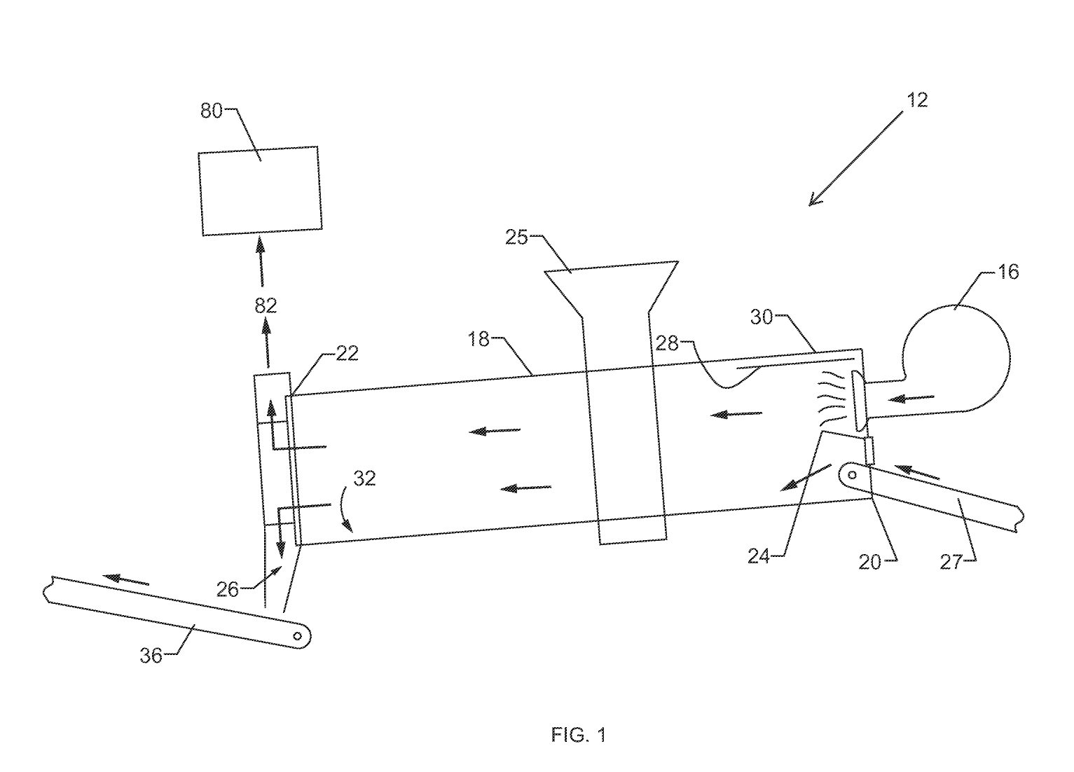

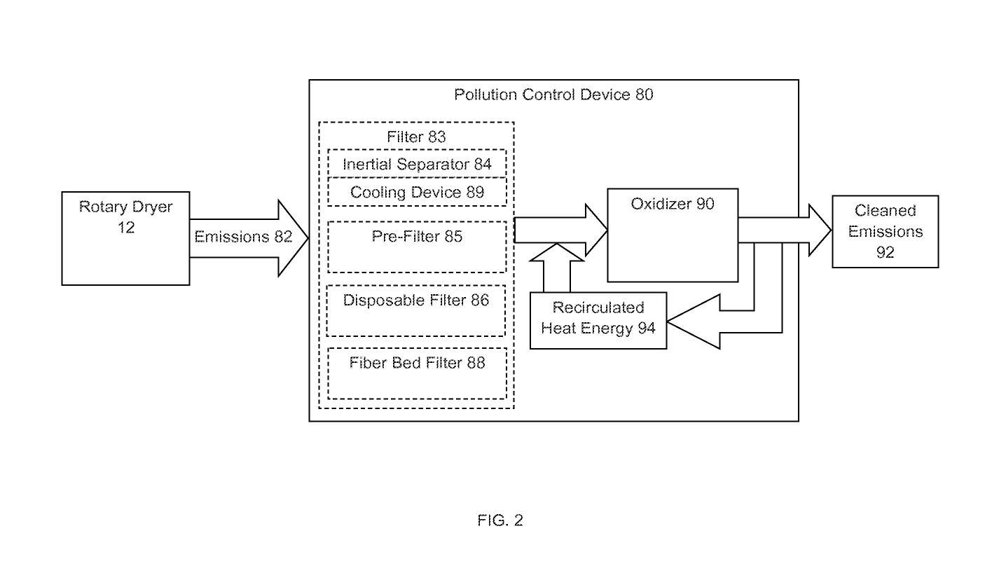

Referring now to FIG. 1, shown is a schematic cross-sectional view of one type of hot-mix asphalt manufacturing system. However, it should be appreciated that other types of asphalt mixing systems are suitable for use with the pollution control system and method. As depicted, the hot-mix asphalt manufacturing system comprises a rotary dryer 12 and at least one pollution control device 80 (shown in detail in FIG. 2). The rotary dryer 12 is adapted to receive ingredients of hot-mix asphalt and to perform a mixing and/or drying process on the ingredients.

Preferably, the rotary dryer 12 is a parallel-flow rotary dryer. The term “parallel-flow” is understood to mean that the materials being dried in the rotary dryer 12 generally flow, or are conveyed, in the same direction as the emissions and/or by-products of the drying process. However, a “counter-flow” dryer, or another type of dryer or system, may also be used, although not limited thereto. In fact, the present teachings can be used with any hot-mix asphalt manufacturing system. Following is an exemplary embodiment of one such system and the present teachings are not limited thereto.

The rotary dryer 12 preferably includes a heat source, such as a burner 16, and a rotatable drum 18 having a first end 20 and an opposite end 22. Inlets 24 and 25 for raw or primary ingredients of the hot-mix asphalt preferably are located at or near the first end 20 of the rotatable drum 18 and at midpoint. An outlet 26 for the hot-mix asphalt manufactured by the rotary dryer 12 can be located at or near the opposite end 22. The raw or primary ingredients can be brought to the inlets 24 and 25 and introduced into the rotatable drum 18 using a conventional conveyor system 27 (e.g., a belt-type conveyor).

The rotary dryer 12 may include a combustion zone 28 in which the burner 16 completes combustion. The combustion zone 28 is internal to the rotatable drum 18 and may include insulation flights radially spaced apart (inwardly) from an inside circumferential wall 30 of the rotatable drum 18. The radial spacing advantageously insulates the circumferential wall 30 from radiant energy of the burner flame. In the parallel flow arrangement, cold damp ingredients are heated quickly by radiant energy of the burner flame and thermal energy of the insulator flights while simultaneously cooling combustion gases before passing through the dryer to the opposite end 22. This heat transfer strategy advantageously minimizes volatilization of hydrocarbons from asphalt coated ingredients introduced at 24 and 25.

In operation, the raw or primary ingredients of the hot-mix asphalt are received through the inlets 24 and 25 for passage through the rotatable drum 18 toward the opposite end 22. At the same time, combustion gases from the combustion zone 28 flow concurrently from the first end 20 of the rotary dryer 12 toward the opposite end 22 to heat and dry said raw ingredients. Supplemental ingredients (or additives) can be introduced into the mixing zone 32 of the rotary dryer 12 so that the supplemental ingredients are mixed with the primary ingredients after the primary ingredients have substantially completed a drying treatment in a drying zone. The supplemental ingredients, for example, can include asphalt cement, rejuvenators, plasticizers, and/or combinations thereof. Downstream (with respect to ingredient flow) of the mixing zone 32, the hot-mix asphalt manufactured by the rotary dryer 12 is allowed to drop through the outlet 26 and onto a hot-mix conveyor system 36.

Referring now to FIG. 2, shown is a diagram of one embodiment of the pollution control device 80 of FIG. 1. The pollution control device 80 treats emissions 82 from the rotary dryer 12. Preferably, the pollution control device 80 includes multiple filtration strategies the combination of which lowers operating costs and extends the service life of the media. The filter assembly 83 (e.g., multiple types of filters) may remove particles and other contaminants from the emissions 82 and may include an inertial separator 84, cooling device 89, pre-filter 85, disposable filter 86, and/or a fiber bed filter 88, although not limited thereto.

The inertial separator 84 may remove airborne particulates larger than 325 micron by slowing velocity sufficiently that gravity will settle material in the bottom of a chamber. Inertial separators can include cyclones, multiclones, expansion chambers, or whirl separators, although not limited thereto. Material may be collected in a hopper where it can be removed automatically or manually (e.g., after some 1,000 tons of production, etc.).

The inertial separator is preferably followed by a pre-filter 85. Pre-filter 85 may be a disposable fiber media that captures oil droplets that are smaller than 325 micron but larger than aerosol mist. Fibers can be synthetic or metallic and characterized by a large media volume to retain captured materials, for example a media volume of about 1 cubic foot of media per 2,000 actual cubic feet per minute (ACFM) of emissions. Synthetic fiber media may have a 1″ thickness while metal media may have a 6-8″ depth, although not limited thereto. Oil droplets may be captured and retained on fibers, ultimately closing voids in media and restricting air flow. When air flow is restricted, as characterized by a pressure differential across the media exceeding a 2″ water column, synthetic media may be replaced and metal media cleaned.

The pre-filter 85 is preferably followed by a disposable filter 86 (e.g., to remove fine particulates smaller than 325 micron that were not retained on pre-filter media, etc.). Disposable media can be glass or synthetic construction with high filtration efficiency (e.g., >85%) at 10 micron, although not limited thereto. This media may be relatively thin (for example, about ⅛″) compared to the pre-filter 85 and with a larger face area such that the ratio of flow rate of the emissions to surface area of the face of the media is less than about 2.5:1 (ACFM/SF). Media may be replaced or washed down when air flow is restricted as characterized by pressure differential across media exceeding a 3″ water column.

The pre-filter 85 is preferably followed by a fiber bed filter 88. The fiber bed filter 88 preferably is configured to provide coalescent filtration of emissions from the rotary dryer 12. The coalescent filtration preferably may be achieved by subjecting the emissions 82 to Brownian diffusion filtration, but not limited thereto.

The hydrocarbon compounds that evaporate off from the asphalt-coated primary ingredients in the hotter zones of the dryer 12 may condense as they exit the rotary dryer 12. These hydrocarbons are relatively long-chain hydrocarbons and condense out from the emissions at temperatures above 120 degrees F. and below 180 degrees F. Many such hydrocarbons will condense out in the rotary dryer 12 to form an aerosol in the emissions (for example an aerosol having droplets with diameters mostly less than 1 μm, but not limited thereto). The condensation of hydrocarbons makes their removal from the emissions more practical because they can be removed using coalescent fiber bed filters 88. In particular, the aerosol may strike the fiber bed filter 88 and coalesce thereon. As coalescing continues, the collection of hydrocarbons becomes enough to overcome surface tension and the coalesced hydrocarbons drop from the fiber bed filter 88 for collection and disposal.

The fiber bed filter 88 can include a plurality of fiber bed filter tubes. Preferably, the filter tubes are arranged vertically and substantially parallel to one another. Each filter tube may be made of densely packed non-woven glass fibers capable of coalescing submicron aerosol. The exterior of each filter tube may be exposed to incoming cooled and/or diluted emissions. The coalesced aerosol may drain down vertical tubes and drop onto a floor of the filter bed housing. The floor may be slanted so that the run-off can be collected and appropriately treated and/or discarded.

Fiber bed filters are not generally used to treat emissions from the traditional hot-mix asphalt manufacturing systems. This is in part because of the high particulate loading in dryer emissions when conventional fresh aggregates are dried in direct fired rotary dryers, and relative absence of hydrocarbon aerosol in exhaust gases. Accordingly, the general perception in the industry of hot-mix manufacturing is that fiber bed filters are not suitable or necessary for use as pollution control equipment in a hot-mix rotary dryer.

The pollution control device 80 may include a cooling device 89 to cool the emissions from the rotary dryer enough that such emissions achieve a temperature that is compatible with the fiber bed filter 88. However, no cooling device may be needed. For example, when using a counter-flow dryer with multiple RAP entry points, it isn't necessary to “superheat” the RAP aggregate, resulting in a lower emission temperature. Such counter-flow dryers are disclosed in the inventor's co-pending U.S. patent application Ser. No. 14/723,163 and Canadian patent application number 2,893,159, the disclosures of which are incorporated herein in their entireties.

The cooling device 89 may include at least one coolant sprayer adapted to spray a coolant into the emissions. The spray of coolant advantageously reduces the temperature of the emissions and causes the majority of the remaining uncondensed hydrocarbons to become condensed. The spray of coolant also encourages particulates to agglomerate and settle in the inertial separator 84.

The aforementioned pre-filter 85 may remove particulates from the emissions including, without limitation, airborne fine particulates. Since some particulates may pass through the coolant spray without becoming engaged to a coolant droplet and some droplets may be swept up in the flow of emissions, the pre-filter 85 may be located between the coolant spray and the fiber bed filter 88 to remove such particulates and droplets. In another embodiment, the pre-filter 85 may be used without a fiber bed filter 88 or cooling device 89, or be followed by the cooling device 89.

The various components of the filter 83 can be arranged in any suitable group and order and are not limited by the above embodiments. Those skilled in the art will have knowledge of other applicable filtration methods and the present teachings are not limited to any particular embodiments disclosed herein.

After the emissions 82 are filtered by the filter 83 they may be sent to an oxidizer 90. An oxidizer is a device that decomposes hazardous gases at a high temperature. The oxidizer may be downstream of the pre-filter 85 and/or a fiber bed 88 (e.g., in a hot-mix asphalt system using substantially recycled content). Use of a pre-filter 85 and/or fiber bed 88 may be preferable since the oils (and other contaminants) in the output of the dryer may negatively affect the oxidizer 90.

The oxidizer 90 may heat the incoming stream of emissions to a very high level (higher than the output of the dryer) to ignite them to react with oxygen to produce CO2 and H2O. Energy/heat is required to initiate the oxidation reaction; however the reaction itself is exothermic and provides heat energy for the oxidation process. In this way, the oxidizer 90 may obtain a high level of removal (e.g., 90-99%) of hydrocarbons, including for example gaseous hydrocarbons. Once the hydrocarbons have been removed, the emissions may be reduced sufficiently to allow larger plants or increased annual operation.

The oxidizer 90 may comprise a thermal or catalytic oxidizer, although not limited thereto. Thermal oxidizers are typically used to destroy Hazardous Air Pollutants (HAPs) and Volatile Organic Compounds (VOCs) from industrial air streams. These pollutants are generally hydrocarbon based and when destroyed via thermal combustion are chemically changed to form CO2 and H2O. The oxidizer 90 may comprise a direct-fired oxidizer, wherein emissions to be treated are introduced into a firing box through or near a burner and heated to, for example, 1600-1800 degrees F. for 0.5 seconds to get the desired destruction removal efficiency (DRE) of the VOCs. A thermal oxidizer may be preferable where there is a very high concentration of VOCs to act as the fuel source (e.g., instead of natural gas or oil) to achieve the targeted operating temperature or where other gases (e.g. sulfur compounds) risk poisoning a catalyst.

In a catalytic oxidizer, catalytic oxidation occurs through a chemical reaction between the VOC hydrocarbon molecules and a precious-metal catalyst bed within the oxidizer. A catalyst is a substance that is used to accelerate the rate of a chemical reaction, allowing the reaction to occur at a lower temperature range (e.g., 550° F. to 650° F. or 275° C. to 350° C.) than required for equal DRE with a thermal oxidizer. One skilled in the art would appreciate the number of ways oxidation may be accomplished and the present teachings are not limited to any particular embodiments disclosed herein.

After the emissions have been “cleaned” by the oxidizer 90 (e.g., hydrocarbons burned off), heat energy may be recovered from the cleaned emissions and recirculated 94 to pre-heat the emissions introduced into the oxidizer. For example, one or more heat exchangers may be used to transfer heat energy from the cleaned emissions to emissions introduced into the oxidizer. Such heat recovery improves the efficiency of the oxidizer by using the heat energy of the (clean) output of the oxidizer 90 to heat incoming (dirty) input from the rotary dryer 12 and/or filter 83 rather than burning fuel in the firing box. The cleaned emissions 92 from the oxidizer 90 may be released directly into the surrounding environment.

Several technologies are suitable for construction of a heat exchanger but porous ceramic media has proven durable and cost effective at elevated temperatures typical of thermal or catalytic oxidizers. With ceramic media there are typically two beds that are alternately heated by cleaned air and then cooled with untreated air. Each bed may have 20:1 ratio of air flow rate (e.g., actual cubic feet air/minute) to volume of ceramic media (e.g., cubic feet ceramic). It is preferable for the heat exchanger to have sufficient mass of media to store/release a large quantity of heat energy during each cycle. Media types may be structured or unstructured, though structured are more efficient and have lower pressure drop. If the untreated air contains hydrocarbon aerosol, those compounds will collect on the surface of the ceramic pores where they may be released into the atmosphere during the subsequent heating phase with clean air. If untreated air contains fine particulate in addition to hydrocarbon aerosol, ceramic media may become blocked by buildup from captured solids, rendering the oxidizer inoperable. The filter 83 (preferably including pre-filter 85 and/or fiber bed filter 88) can remove the fine particulate and hydrocarbon aerosol prior to the oxidizer (and heat exchanger), to help make use of heat exchanger technology possible.

A system according to the present teachings provides a superior pollution control system that may be preferable to use with RAP. This is because undesirable hydrocarbon emissions can be created in addition to fine particulates when exposing asphalt coated RAP to hot combustion gases. Despite the fact that more hydrocarbon emissions may be created when using RAP, the pollution control device disclosed herein may achieve the desired level of hydrocarbon and particulate removal (e.g., 90-99%), which may be required by certain regulations without great expense or excessive periodic maintenance.

Other filtration strategies have been employed to remove particulates and hydrocarbon aerosol, but with poor outcomes. In particular, conventional baghouses with Nomex or polyester bags were used in combination with bag pre-coat to adsorb hydrocarbon aerosol. Low cost polyester bags have caught fire when exhaust gas temperatures reached a flash point of collected oils. Costly Nomex bags had short service life as fiber became oil soaked and particulate dust bonded to sticky oils.

While the present teachings have been described above in terms of specific embodiments, it is to be understood that they are not limited to these disclosed embodiments. Many modifications and other embodiments will come to mind to those skilled in the art to which this pertains, and which are intended to be and are covered by this disclosure. It is intended that the scope of the present teachings should be determined by proper interpretation and construction of the disclosure and its legal equivalents, as understood by those of skill in the art relying upon the specification and the attached drawings.

What is claimed is:

1. A system for producing hot-mix asphalt comprising:
a rotary dryer comprising a rotatable drum with first and second ends, at least one inlet, at least one outlet, and a heat source;
a pollution control device comprising a filter assembly and an oxidizer, the filter assembly comprising at least one of an inertial separator, a pre-filter, a disposable filter, and a fiber bed filter;
the rotary dryer being operable to receive an aggregate through the at least one inlet, mix and heat the aggregate using the rotatable drum and the heat source, and expel an asphalt product and emissions through the at least one outlet;
the pollution control device being operable to receive the emissions from the at least one outlet;
the filter assembly being operable to substantially remove particulates and hydrocarbon aerosol from the emissions; and
the oxidizer being operable to substantially remove gaseous hydrocarbon pollutants from the emissions.

2. The system of claim 1, wherein the pollution control device is operable to remove at least 90 percent of particulates and contaminates and at least 90 percent of hydrocarbon pollutants from the emissions.

3. The system of claim 1, wherein the rotary dryer comprises a parallel-flow rotary dryer.

4. The system of claim 1, wherein the rotary dryer comprises a counter-flow rotary dryer.

5. The system of claim 1, wherein the pollution control device further comprises a cooling device.

6. The system of claim 5, wherein the inertial separator comprises the cooling device and the cooling device comprises a cooling spray.

7. The system of claim 1, wherein the filter assembly comprises the inertial separator and at least one of the fiber bed filter, the pre-filter, and the disposable filter.

8. The system of claim 1, wherein the filter assembly comprises all of the inertial separator, the pre-filter, the disposable filter, and the fiber bed filter.

9. The system of claim 1, wherein the oxidizer comprises a catalytic oxidizer.

10. The system of claim 1, wherein the oxidizer comprises a thermal oxidizer.

11. The system of claim 1, wherein the oxidizer comprises a direct-fired oxidizer.

12. The system of claim 1, further comprising at least one heat exchanger, the heat exchanger being operable to recover heat from emissions leaving the oxidizer and recirculate the heat to emissions introduced into the oxidizer.

13. The system of claim 12, wherein the at least one heat exchanger comprises porous ceramic media.

14. A pollution control system for hot-mix asphalt manufacturing, comprising:
a filter assembly;
an oxidizer;
the filter assembly comprising at least one of an inertial separator, a pre-filter, a disposable filter, and a fiber bed filter;
the filter assembly being operable to receive emissions from manufacturing equipment, substantially remove particulates and hydrocarbon aerosol from the emissions, and send the emissions to the oxidizer; and
the oxidizer being operable to receive the emissions from the filter assembly, substantially remove gaseous hydrocarbon pollutants from the emissions, and release the emissions into the surrounding environment.

15. The pollution control system of claim 14, further comprising a cooling device operable to cool the emissions.

16. The pollution control system of claim 15, wherein the inertial separator comprises the cooling device and the cooling device comprises a cooling spray.

17. The pollution control system of claim 14, wherein the filter assembly comprises the inertial separator and at least one of the fiber bed filter, the pre-filter, and the disposable filter.

18. The pollution control system of claim 14, wherein the filter assembly comprises all of the inertial separator, the pre-filter, the disposable filter, and the fiber bed filter.

19. The pollution control system of claim 14, further comprising at least one heat exchanger, the heat exchanger being operable to recover heat from emissions leaving the oxidizer and recirculate the heat to emissions introduced into the oxidizer.

20. The pollution control system of claim 19, wherein the at least one heat exchanger comprises porous ceramic media.

21. A method of producing hot mix asphalt comprising the steps of:
providing a rotary dryer comprising a rotatable drum with first and second ends, at least one inlet, at least one outlet, and a heat source;
providing a pollution control device comprising a filter assembly and an oxidizer, the filter assembly comprising at least one of an inertial separator, a pre-filter, a disposable filter, and a fiber bed filter;
introducing an aggregate into the at least one inlet of the rotary dryer;
mixing the aggregate using the rotatable drum and heating the aggregate using the heat source, to produce a hot mix asphalt product and emissions;
introducing the emissions from the rotary dryer into the pollution control device;
filtering particulates and contaminates from the emissions through the filter assembly using the at least one of inertial separator, pre-filter, disposable filter, and fiber bed filter;
passing the emissions from the filter assembly to the oxidizer; and
heating the emissions in the oxidizer to remove hydrocarbon pollutants from the emissions.

22. The method of claim 21, further comprising:
providing the pollution control device further comprising a heat exchanger;
capturing heat from the emissions exiting the oxidizer using the heat exchanger; and
transferring the captured heat into emissions entering the oxidizer using the heat exchanger.

23. The method of claim 22, wherein the heat exchanger comprises porous ceramic media.

24. The method of claim 21, wherein the pollution control device further comprises a cooling device; and
the method further comprises the step of cooling the emissions using the cooling device.

25. The method of claim 21, wherein the aggregate substantially comprises recycled asphalt product.

26. The method of claim 25, wherein a majority of the aggregate comprises recycled asphalt product.

27. The method of claim 26, wherein all of the aggregate comprises recycled asphalt product.

28. The method of claim 21, wherein the filter assembly comprises the inertial separator and at least one of the fiber bed filter, the pre-filter, and disposable filter.

29. The method of claim 21, wherein the filter assembly comprises all of the inertial separator, pre-filter, disposable filter, the fiber bed filter.

30. The method of claim 29, wherein the filter assembly further comprises a cooling device.
